(19) United States
(12) Patent Application Publication
(10) Pub. No.: US 2026/0370792 A1
(43) Pub. Date: Nov. 19, 2026

(54) AN IMAGING METHOD AND AN IMAGING DEVICE

(71) Applicant: Temporal Research Ltd, St Ives, Cambridgeshire (GB)

(72) Inventor: Atma HEERAH, St Ives, Cambridgeshire (GB)

(21) Appl. No.: 19/136,705

(22) PCT Filed: Dec. 13, 2023
(86) PCT No.: PCT/GB2023/053207

§ 371 Date: Jun. 6, 2025

(30) Foreign Application Priority Data
Dec. 13, 2022 (GB) 2218713.2

(51) Int. Cl. H04N 13/302; G06F 3/01; G06T 13/20; H04N 13/00; H04N 13/239; H04N 13/261; H04N 13/398

(52) U.S. Cl. CPC H04N 13/302; G06F 3/017; G06T 13/20; H04N 13/239; H04N 13/261; H04N 13/398; H04N 2013/0081

(57) ABSTRACT

An imaging method and an imaging device (100) are disclosed. A display (3) can be used to display to a user an autostereoscopic image. The autostereoscopic image includes a feature which appears in a region (1) above the display (3). A detection unit (4) detects a gesture performed by the user in the region (1) above the display. An update unit is configured to update the feature in response to the gesture.

### TECHNICAL FIELD

This disclosure relates to an imaging method and an imaging device. In particular, this disclosure relates to the displaying of an image that includes a feature which appears in a region above a display, and the detecting of a gesture that is performed in the region above the display.

### BACKGROUND

It's very common for touch screens to be provided for use by members of the public, with a broad variety of applications including self-service checkouts in shops. Displays are typically used to output information to a user, as well as receiving commands that are input by the user. The coronavirus pandemic has motivated improvements in the hygiene of infrastructure that is shared by different people.

Ways have been developed to clean infrastructure such as touch screens. It has become routine for many retailers to invest in vast quantities of hand sanitiser and disposable paper towels. For such retailers, this has resulted in increased staff intervention, less efficient checkouts and a massive increase in biohazard waste. A widely held view that smartphone automation can provide a solution has been refuted, because studies have shown that the mobile phone touchscreen is itself is a vector of transmission.

Touchless human interfaces have been recognised as more sanitary for users, however, adoption has been limited due to cost, integration and retrofitting issues. In particular current naked eye 3D solutions require specialist software applications to generate images and user interfaces. Due to the complexity of the 3D calculations the user facing images have to be calculated offline and then recalled in the correct sequence in response to the user input. Currently, a touchless device that can utilized as a drop in replacement for a touchscreen is not available.

The present disclosure recognised that innovation is to be found in designing displays that make use of Integral Imaging (InIm), which is a field of technology that was originally proposed by G. Lippmann (“Épreuves réversibles. Photographies intégrales,” C. R. Acad. Sci. 146, 446-451).

Integral Images are continuous parallax images that can be recorded for display with a 2D image and an optical array and viewed with the naked eye. The optical array may be a sheet of small lenses (micro-lens array) or pinhole array or an alternative optical arrangement that performs the image reconstruction. The 2D images contain information about a volume of space including horizontal and vertical parallax. Current commercial applications of InIm are limited to high cost specialised areas such as microscopy.

FIG. 1B shows a conventional integral imaging arrangement 10. The arrangement 10 is applicable to image display or image pickup of a 3D object 11. The arrangement 10 shows a microlens array (MLA) 12 positioned with respect to a screen (13, 14). For an image display device, the screen serves as a 2D display 13 which has pixels which emit light (e.g., red, green and blue light for a colour display), such that this light from the display 13 is directed by the MLA 12 to provide the image of the 3D object 11. For an image pickup device, the screen serves as a camera 14 which has sensors which are sensitive to light (e.g., red, green and blue light), such that the light is directed by the MLA 12 from the 3D object 11 to the camera 14.

Reconstructed images are viewable in lobes with the main frontal lobe normally having a viewing angle of 30-35 degrees. The MLA 12 and the screen (13, 14) are separated by a barrier. The barrier shown in FIG. 1B is to prevent flipping or sudden image changes and can be costly to manufacture on a micro level.

Methods are known for estimating the x, y, and z locations of objects. The use of stereo cameras generally consists of identifying the objects and then using disparity (relative displacement) to estimate depth. Horizontal and vertical dimensions are estimated using triangulation.

Identification of foreground objects in images can be done by comparison with a background image and may include tracking image differences or motion to establish disparity. The following description deals mainly with the location of objects near the cameras once they have been identified as objects. However, the arrangement does inherently make identification of such objects easier.

Existing passive methods using stereo cameras are aimed at capturing scenes from around 1 metre to 100 metres. Outside of this range these methods have poor accuracy. To improve the location of objects near to the cameras, methods use active sensors such as Time of Flight (ToF) devices. The inclusion of a third sensor improves the near field measurement but does not deal accurately with objects very close (a few centimetres) from the sensor and are also complex and costly.

A possible depth estimation technique is to use stereo cameras in parallel configurations or slightly angled towards each other. However, this depth estimation is only considered viable in the far region where disparity reduces with distance. At close distances with angled cameras, near and far objects can be confused.

### SUMMARY

Aspects of the present invention are set out by the claims.

Disclosure is presented of methods and implementation allowing the construction of a device that is a drop in replacement for conventional touchscreens. Existing applications can be used with the human interface floated above the screen. 2D images can be floated at a set distance above the screen with a touchless pointer function coplanar with the floating image. All images fed to the device are automatically and seamlessly converted into integral images for display in 3D space.

As a first aspect, disclosure is provided of an imaging method comprising: displaying to a user an autostereoscopic image that includes a feature which appears in a region above a display; detecting a gesture performed by the user in the region above the display; and updating the feature in response to the gesture.

The autostereoscopic image is an integral image which is configured to be displayed using an optical array.

Optionally, the feature comprises a virtual button; the gesture comprises a selection of the virtual button; and the updating comprises providing an indication of the virtual button being selected.

Optionally, the updating includes an animation of the autostereoscopic image, wherein the feature appears to move in the region above the autostereoscopic image. This can give the user the indication that a virtual button is being pressed.

Optionally, the method further comprises generating an autostereoscopic image from a non-autostereoscopic image in real time enabling video display.

Optionally, the method further comprises a lookup table to maximise processing efficiency.

Optionally, the method further comprises modifying the autostereoscopic image in response to sensor data to present more information and enhance the user experience in a three dimensional way.

Optionally, the method further comprises providing a feedback signal which coincides with the gesture being detected.

Optionally, the method further comprises generating an autostereoscopic image from a non-autostereoscopic image.

Optionally, the method further comprises: identifying a foreground of the image; defining a region in the foreground of the image that is occupied by a moving object; and interpreting whether the moving object is providing the gesture.

Optionally, the method further comprises detecting a change in size and/or a change in disparity of the moving object, in order to define the region occupied by the moving object.

As a second aspect, disclosure is provided of a method for detecting a gesture, the method comprising: identifying a foreground of the image; defining a region in the foreground of the image that is occupied by a moving object; and interpreting whether the moving object is providing the gesture.

Optionally, identifying the foreground of the image comprises using a number of reference lines to identify a bounded volume in front of a detection unit.

Optionally, the method further comprises performing near field focusing to distinguish between a first object that occupies the foreground of the image and a second object that occupies a background of the image.

Optionally, the method further comprises detecting a change in size and/or a change in disparity of the moving object, in order to define the region occupied by the moving object.

Optionally, the method further comprises interpreting whether the moving object is providing the gesture comprises determining whether the moving object can serve as a pointer.

Optionally, the method further comprises interpreting whether the moving object is providing the gesture comprises performing object location by referencing data that is stored by a look up table or a memory.

Disclosure is provided of a combination of the first aspect (which may include any optional feature thereof) and the second aspect (which may include any optional feature thereof).

As a third aspect, disclosure is provided of a program which, when executed by a computer, causes the computer to perform a method according to the first aspect or the second aspect.

As a fourth aspect, disclosure is provided of a computer-readable storage medium storing a program according to the third aspect.

As a fifth aspect, disclosure is provided of a imaging device comprising: a display configured to display to a user a autostereoscopic image that includes a feature which appears in a region above a display; a detection unit configured to detect a gesture performed by the user in the region above the display; and an update unit configured to update the feature in response to the gesture.

The autostereoscopic image is an integral image; and the display comprises an optical array configured to display the integral image.

Optionally, the optical array has a flat surface which is configured to face the user.

Optionally, the optical array covers a portion of the display. The optical array does not cover all of the display. Thus, a first portion of the display is covered by the optical array, and a second portion of the display is not covered by the optical array. The portion of the display which is covered by the optical array can be used to display a three dimensional image and/or a two dimensional image. The portion of the display which is not covered by the optical array can be used to display a two dimensional image.

Optionally, the imaging device further comprises at least two image sensors configured to capture a stereoscopic image of an object in the region; wherein the detection unit is configured to detect the gesture by identifying a disparity in the stereoscopic image of the object that has been captured by the at least two image sensors.

Optionally, the display is configured to display a virtual keypad.

Optionally, the imaging device further comprises a card reader configured to read information that is stored on a card that is presented by the user.

Optionally, the imaging device further comprises a feedback unit configured to provide a feedback signal which coincides with the gesture being detected by the detection unit.

Optionally, the imaging device further comprises means to generate an autostereoscopic image from a non-autostereoscopic image.

Optionally, the imaging device further comprises means to generate an autostereoscopic image from a non-autostereoscopic image in real time enabling video display and seamless system integration.

Optionally, the imaging device further comprises a lookup table to maximise processing efficiency and reduce power consumption compared to established calculation methods.

Optionally, the imaging device further comprises means to modify the autostereoscopic image in response to sensor data making the device more user friendly, intuitive and increasing productivity compared to alternative human interfaces.

As a sixth aspect, disclosure is provided of a device configured to detect a gesture, the apparatus comprising: an identification unit configured to identify a foreground of the image; a defining unit configured to define a region in the foreground of the image that is occupied by a moving object; and an interpreting unit configured to interpret whether the moving object is providing the gesture.

As a seventh aspect, disclosure is provided of an imaging method comprising generating an autostereoscopic image from a non-autostereoscopic image in real time enabling video display.

Optionally, the imaging method further comprises a look up table.

Optionally, the imaging method further comprises autostereoscopic image responses to sensor data.

As an eighth aspect, disclosure is provided of an imaging device comprising means to generate an autostereoscopic image from a non-autostereoscopic image in real time enabling video display.

Optionally, the imaging device further comprises a look up table.

Optionally, the imaging method further comprises autostereoscopic image responses to sensor data.

A solution is disclosed which does not have barriers due to the problem being reduced by the gap g being a minimum. The disclosed software can also reduce this problem. For secure applications like access systems, viewing angle improvement is unnecessary for privacy reasons. In fact the system is inherently more secure than normal keypads as someone standing next to the user will see a different lobe to the user and find it difficult to establish the key being pressed.

This disclosure relates to a way of providing the general public with displays that make use of Integral Imaging (InIm). This is achieved using displays that include mass produced precision parts, with these displays being coupled with innovative software. These displays allow images to be displayed that appear to be in front of the display. This is referred to as Float Photon (trade mark) InIm technology, which includes the following advantages:
1. A true optical model is generated in space, with the result that the image is autostereoscopic (no glasses).
2. In viewing, ocular accommodation and convergence work in unison meaning 3D does not rely on unnatural brain combination of left and right images. At least 15% of the population cannot do this combination and of those remaining a significant percentage get headaches.
3. Images retain 3D features under monocular viewing, via accommodation and motion parallax so assists the visually impaired.
4. Images have horizontal and vertical parallax.
5. Compatible with 2D image processing.
6. Does not require huge amounts of data.
7. No potentially hazardous lasers or specialised projection equipment.
8. Viewing does not require special lighting conditions.
9. Cost effective and compact.
10. Suitable for high volume manufacture.

Existing holographic solutions are deficient in advantages 5, 6, 7, 8, 9 and 10 whilst existing lenticular light field solutions are deficient in advantages 1, 2, 3, 4, 9 and 10.

Innovative aspects that have been developed include the image creation algorithms, the pointer/finger detection methodology and the overall arrangement that delivers low cost result.

### BRIEF DESCRIPTION OF THE DRAWINGS

Embodiments will now be described, by way of example only, with reference to the accompanying drawings, in which:

FIG. 1A shows the front view of a typical microlens array;

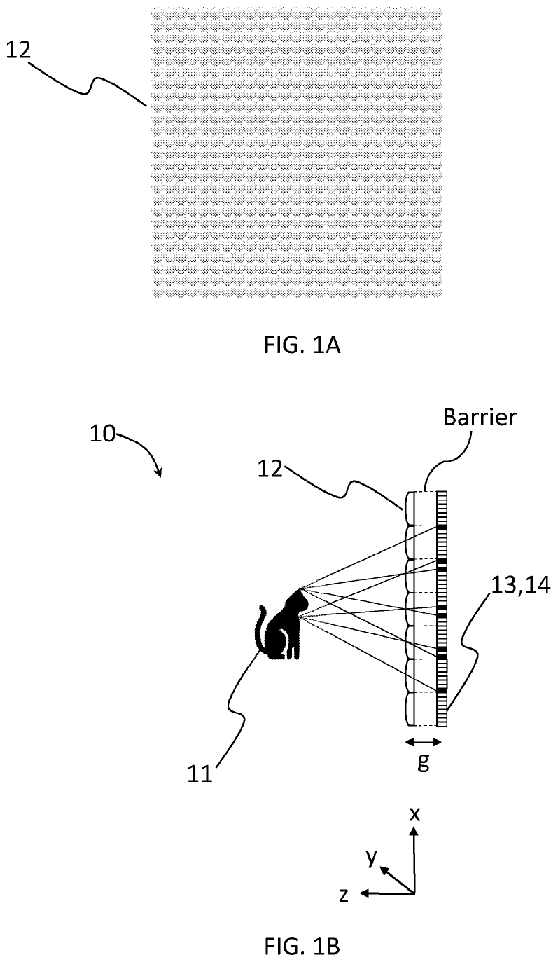

FIG. 1B shows a conventional integral imaging arrangement;

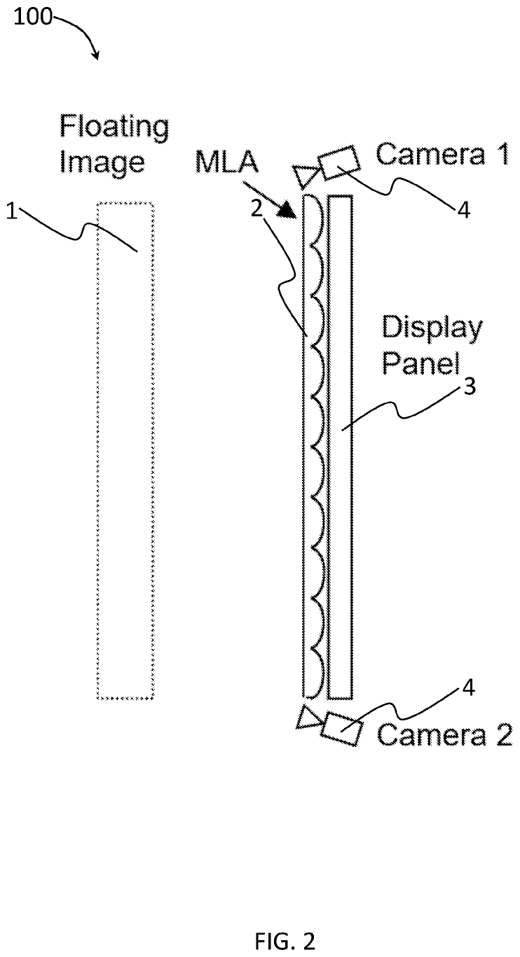

FIG. 2 shows an improved integral imaging arrangement;

FIGS. 3A-D show views from different angles of a display configured to display a stereoscopic image;

FIG. 4 provides a schematic arrangement of an imaging device;

FIG. 5 shows two parallel image sensors embodied as cameras arranged to create a stereoscopic image, together with details of depth estimation and disparity;

FIG. 6 shows an arrangement for the detection of near field objects coexisting with a 3D image floating above a display, together with details of foreground images and foreground disparity;

FIG. 7A shows a conventional InIm capture or display setup;

FIG. 7B shows an example of how the object distances are calculated;

FIG. 8A is a flow chart showing an imaging method that is implemented;

FIG. 8B is a flow chart showing a pointer detection method that is implemented;

FIG. 8C is a flowchart showing the real time conversion methodology of non-autostereoscopic images to autostereoscopic images; and

FIG. 9A-C provides some possible details of an imaging device, with FIG. 9A showing a hardware topology; FIG. 9B showing a software topology; and FIG. 9C showing some applications of the imaging device.

### DETAILED DESCRIPTION

Various exemplary embodiments, features, and aspects are described in detail below with reference to the drawings.

Disclosure is provided of a user being presented with an autostereoscopic image.

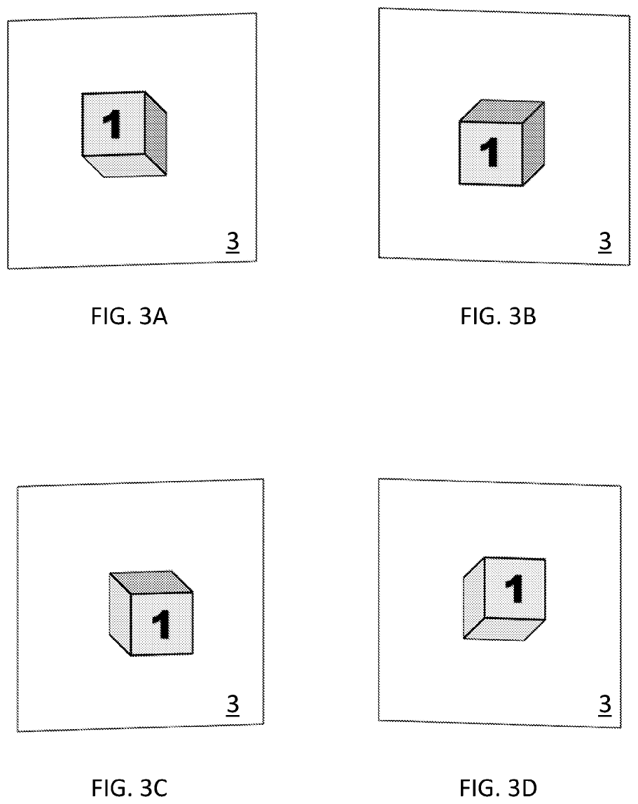

FIG. 2 shows an improved integral imaging arrangement 100, for which the autostereoscopic image is an Integral Image (InIm). A floating image 1 is shown which has been created using an array of microlenses (MLA) 2 to project a 2D image which is displayed by a display panel 3. The 2D image may appear to the user as a 3D image. The user is presented with floating image 1, which includes a feature that appears to occupy a region above the display 3 (i.e., the 3D image appears to be coming out of the screen towards the user). A distinctive feature is that the 2D image is not binocular. i.e. separated into areas for left and right eye viewing.

The integral imaging arrangement 100 further includes cameras 4 which monitor the region in which the floating image 1 is displayed. The cameras 4 are configured to detect movement in this region, such as a gesture that is performed by the user. The combination of displaying an Integral Image (InIm) with finger detection allows user interaction, which is achieved by updating the stereoscopic image based on the gesture, so that the 3D feature appears to be moved by the user performing the gesture. Existing mid-air control interfaces are not intuitive and not suitable for secure systems where privacy is important.

A Float Photon Interface (FPI) is introduced that uses camaras for pointer/mouse functionality, resulting in a touchless screen, as shown in FIG. 2. Using acutely angled stereo cameras, the near field image in front of the screen is captured and automatically recognises close foreground objects and their distance from the screen using disparity between left and right images. Such touchless methodology is applicable to both 2D and 3D displays. Multi-touch response is possible, as is button animation to show downward movement in response to a button press. The micro-lens array (MLA) 2 has a flat face which faces the user, giving a surface that can easily be dusted, and allowing a touchscreen to coexist with the float photon interface. This example shows the use of a micro-lens array 2, although the disclosure extends to the use of any optical component 2 which confers the functionality of projecting a 2D image which is being displayed.

Innovation is found in the way in which the touchless mouse functionality using foreground/background separation and the mid-air button animation being done by using the finger position to alter the constructed image. A variety of ways are well-known for the construction and the animation of a stereoscopic image. For example, processing left and right images separately using standard techniques before combining them into a viewing format. The animation of the stereoscopic image provides the user with feedback which indicates that the gesture has been detected. The imaging device 100 includes a feedback unit which can provide a feedback signal that coincides with the gesture being detected. Possible feedback units include a speaker configured to provide an audio signal, and a haptic device configured to provide a haptic signal. Advantages of these methods include computational and mechanical simplicity. Wide angled cameras can be located behind a standard flat bezel without raised parts around the edge of the screen as would be required by an infra-red or other beam interruption solution operating in front of the screen.

The potential of the technology can be demonstrated with a non-optimised arrangement consisting of 2017 Google phone (registered trade mark) and a micro lens array (MLA). Note that the 3D images have restricted depth of field due to the presence of Gorilla Glass (registered trade mark) over the OLED display. Depth of field is related to gap g and this is much larger than the optimum.

Tests show that a floating keypad around 25 mm above the display is sufficient for users to avoid contact with the display surface. Furthermore, users have a natural incentive not to press excessively and will be reminded with user feedback when the selection is registered.

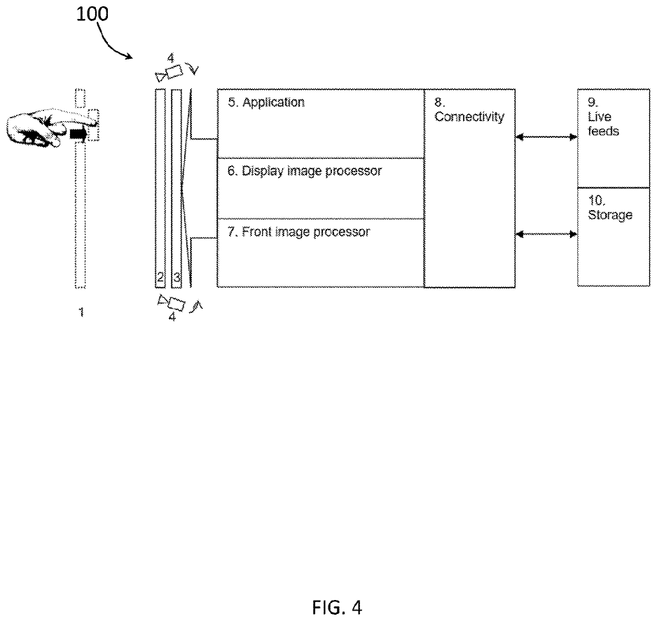

FIGS. 3A-D show views from different angles of a display 3 configured to display an autostereoscopic image 1. The autostereoscopic image shows a floating cube 1 that appears to be at around 20 mm above the display 3. FIGS. 3A-D illustrate the cube 1, showing full horizontal and vertical views from four different angles.

An application of this technology is for this display 3 to be installed in a mobile device, such as a smartphone or a card payment reader. The virtual buttons can be arranged to provide a virtual keyboard or a virtual keypad. The display 3 may display one or more virtual button which can be selected by the user by performing a gesture of pressing the button with their finger or a stylus. A user typically indicates button selection by performing a press gesture by moving their finger towards the display, and then moving their finger away from the display.

Selection of a virtual button is confirmed to the user by the display presenting an animation, which shows the button being pressed. The animation indicates to the user that a selection gesture is being performed. While the finger is moving towards the display, the button appears to move from a first position that is further away from the display, to a second position that is closer to the display. While the finger is moving away from the display, the button appears to move from the second position that is closer to the display, back to the first position that is further away from the display. Accordingly, the image is updated to indicate the virtual button being selected.

A secure application such as a card payment reader typically includes a numeric keypad. An InIm keypad will typically be arranged with keys 4, 5, 6, arranged horizontally and keys 9, 6, 3 and decimal point arranged vertically.

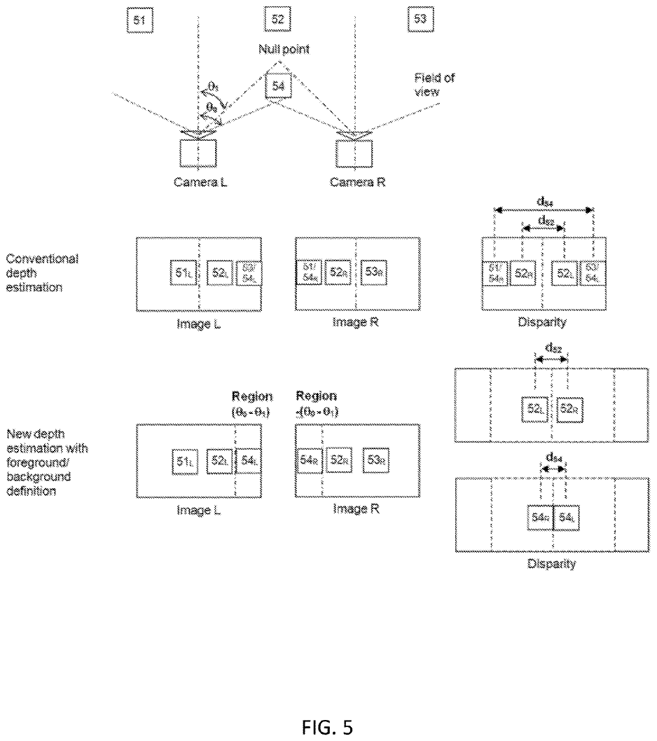

FIG. 4 shows a schematic arrangement of an imaging device 100. A floating image 1 is shown which is created using an optical component 2 to image a flat screen display 3. The imaging device 100 includes application software 5, a display image processor 6, and a front image processor 7. Optionally, an input/output (I/O) unit 8 is used to provide a connection with any number of live feeds 9 and/or any number of memory storage devices 10. Note that the illustrated components can be implemented as hardware, firmware, software, or a mixture of all three.

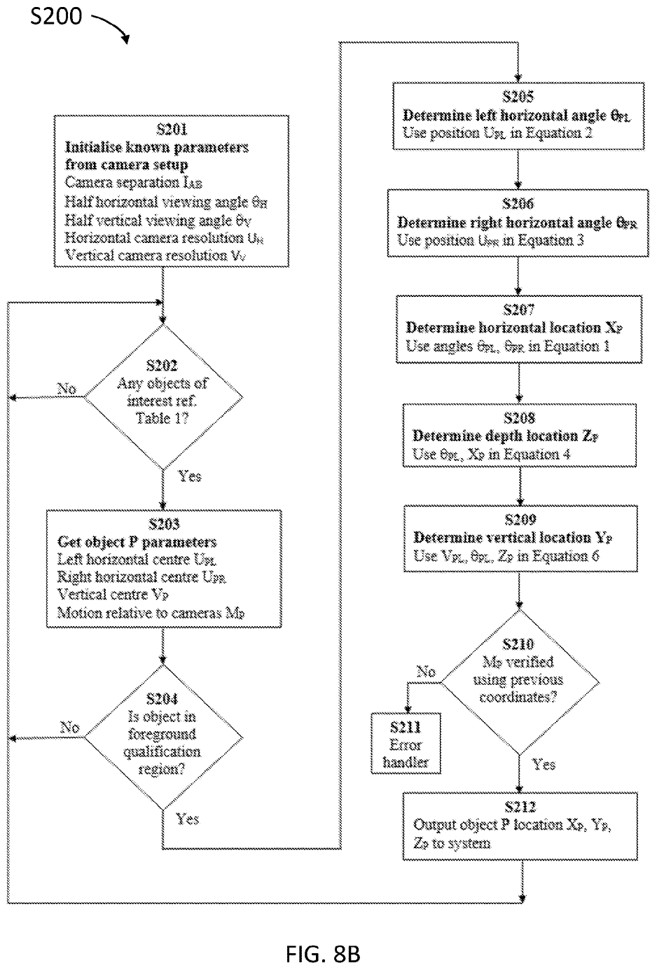

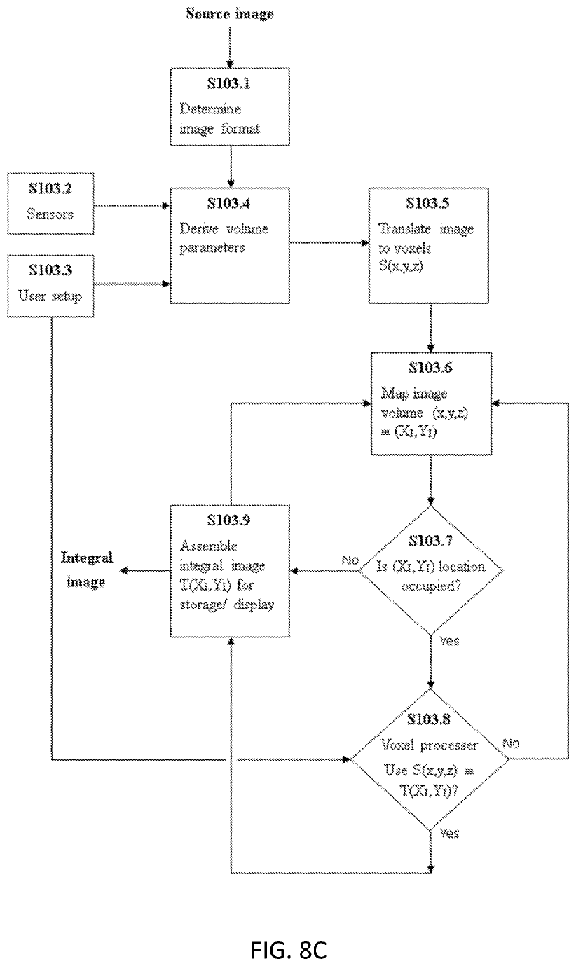

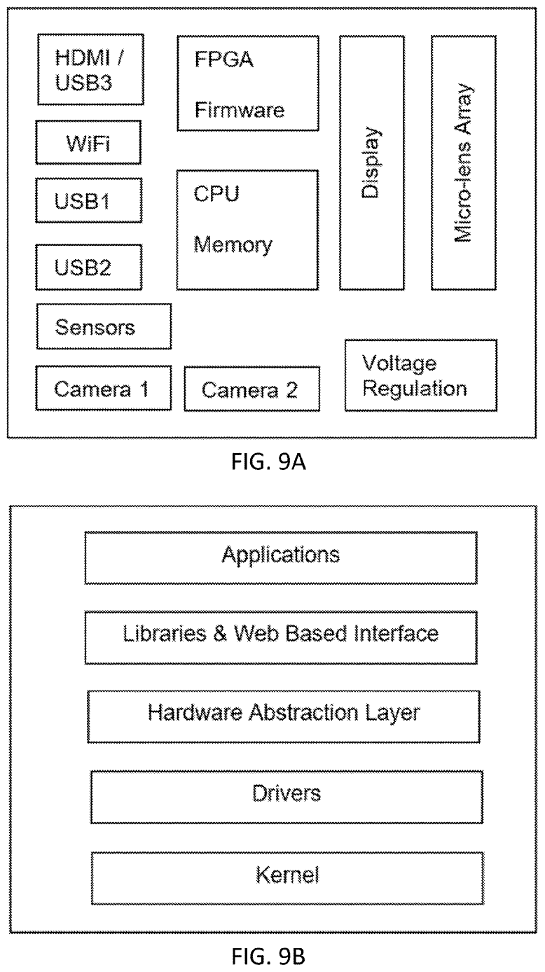

The floating image 1 provides a 3D image of a 2D integral image which is produced by the display 3. The floating 3D image 1 appears at varying depths to illustrate animation, with a push gesture being depicted by the user's finger moving towards the display. A number of ways are well-known for creating integral images including using third party modelling tools such as Autodesk 3ds Max (registered trademark), however, the method described in FIG. 8C represents the fastest and most efficient way of creating integral images from non-integral images. Thus, the floating 3D image 1 is generated from hardware, firmware and software components, with the user pushing a floating button that animates downwards with the finger press.

The optical component 2 is arranged in front of the display 3. The optical component 2 is typically a lens array (such as a microlens array (MLA)) or pinhole array that is configured to construct the 3D image 1 from the integral image (InIm) that is displayed by the display 3. The flat screen display 3 may or may not include a touchscreen to display integral images (InIms) that are generated by the application 5, the display image processor 6, the front image processor 7, or any combination of the three. Optionally, the touchscreen can be integrated into the optical component (e.g., the microlens array (MLA)) 2.

Two or more cameras 4 are positioned to capture a near field view of the volume around the floating image 1. Captured content is fed from the cameras 4 to the front image processor 7 for processing. The content can include stereoscopic or depth information. To optimise scene capture, the cameras 4 can be rotated or repositioned to an optimum angle, either electronically or mechanically. Optionally, the cameras have a focal length and a depth of field that can also be varied optically or electronically.

The application 5 determines the overall function that the device 100 performs for the user, for example, the device 100 serving as a credit card reader. The application 5 determines what functionality is to be performed by the display image processor 6, the front image processor 7, and the I/O unit 8. Thus, the application 5 is in control of configuring the display 3 to present to the user an integral image that is based on input that is received from the front image processor 7 or via the I/O unit 8.

The display image processor 6 is configured to process images for the display 3 based on instructions received from the application 5. The source image information can come from the front image processor 7 directly or from a live feed 9 and/or a memory 10 via the I/O connectivity unit 8. One process is the conversion of real time (video rate) 2D images to InIms that are perceived as 2D images that float a set distance from the display 3. Another is the real time conversion of 2D images plus depth (2DD) to InIms that are perceived as 3D floating images. An additional process can alter the InIm generated in real time in response to input from the front image processor 7. This allows part of the constructed image to vary in depth enabling button animation in response to a push event.

The front image processor 7 is configured to processes images received from the cameras 4, to implement a touchless human interface by identifying objects close to the optical component 2, and calculating their 3D position. This near field technique has advantages over existing visual tracking and artificial intelligence (AI) camera solutions, because of its simplicity. The front image processor 7 can also process 2D and 3D scene images and video for conversion into InIms by the display image processor 6 or direct transmission to the live feeds 9 and/or the memory storage 10.

Connectivity is achieved using the input/output (I/O) unit 8, which can implement an internal software process or USB, wireless or other established interfacing techniques.

Live stream input from one or more live feed 9 is where real time video (2D, 2DD or 3D) or an image is streamed into the display image processor 6 for processing. Live stream output to one or more live feed 9 is where real time video (2D, 2DD or 3D) or an image is streamed out having been processed by the display image processor 6.

A memory 10 that is used for storage can be solid state or non-solid state, and can be used for storing programs, processed and source images and videos.

Whilst conventional ray tracing techniques and third party software can convert 3D images to integral images, these techniques are two slow for real time operation and require the images to be processed offline in order to be ready for display when required. This is understandable given that potentially the entire volume of 3D space has to be processed for each micro-lens in the micro-lens array. Detailed below is the method for real time conversion of 2D, 2DD or 3DD images to integral images.

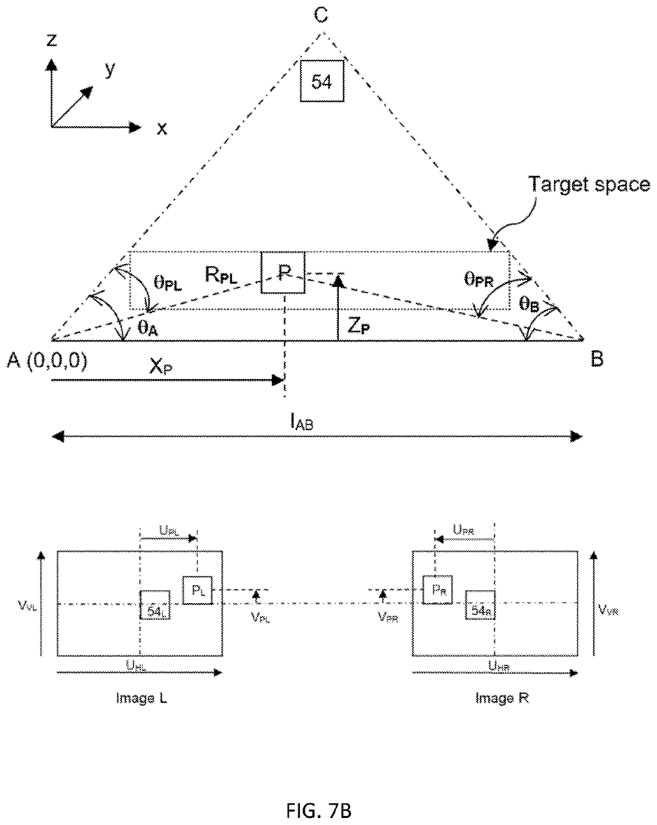

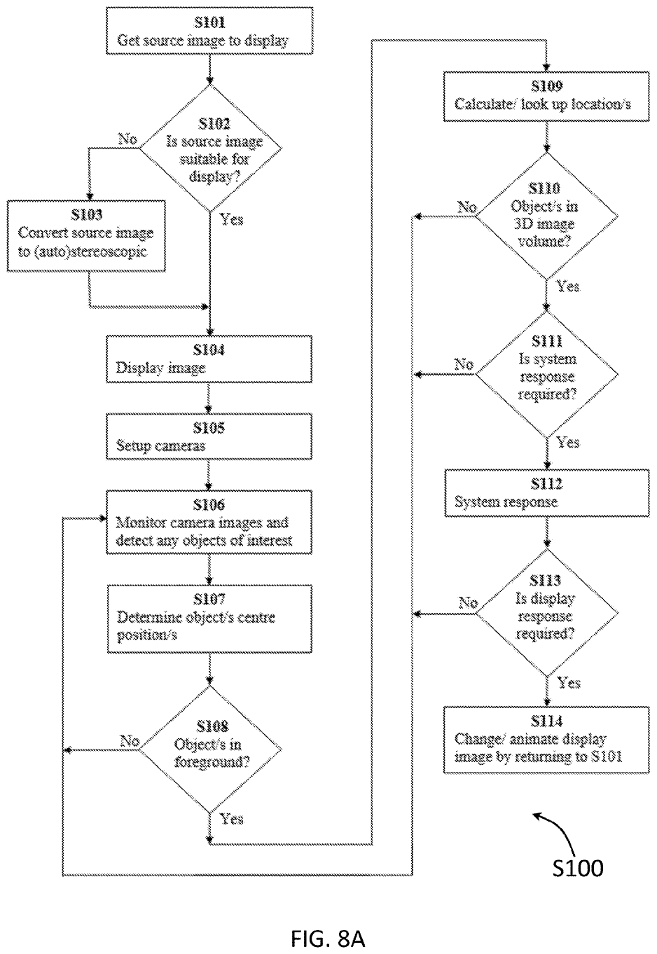

FIG. 7A shows a conventional InIm capture or display setup. In capture mode the volume (74) made up of voxels (75) is captured using the optical component (72) that includes a lens array in front of an image sensor (71). The components can be hardware or software or a combination of both. The value of each voxel at a particular location in the volume is denoted by S(x,y,z). The value of each pixel in the image sensor or display is denoted by T(X_{I},Y_{I}). S(x,y,z) and T(X_{I},Y_{I}) are typically red, green and blue (RGB) values.

In this proposed embodiment ray optics is used to trace each voxel location through each lens (73) to a location on (71). Each lens (73) has a corresponding pixel area (76) on the image sensor (71). All voxel locations are defined in the InIm because the InIm is not resolution limited and is independent of display resolution. Location equivalency can be stated as S(x,y,z)≡T(X_{I},Y_{I})≡S(X_{I},Y_{I}). A given volume and micro-lens specification allows a look up table to be generated offline. This table can be used in real time operations as ray tracing calculations are eliminated as illustrated in FIG. 8C.

For display purposes the InIm is resolution limited by the display panel and down sampling is required. This can be but is not limited to nearest voxel by rounding or truncation or an interpolation of surrounding voxels.

### General Principles

The image presented by the display includes a foreground and a background. The foreground region is in the vicinity of the display. The camera is configured to detect a moving object. If the foreground is occupied by the moving object, then a region of the image is defined that includes the moving object. The definition of this region is based upon detecting a change in the size and/or a change in the disparity of the moving object. The image detected by the cameras is interpreted to assess whether the moving object is providing a gesture.

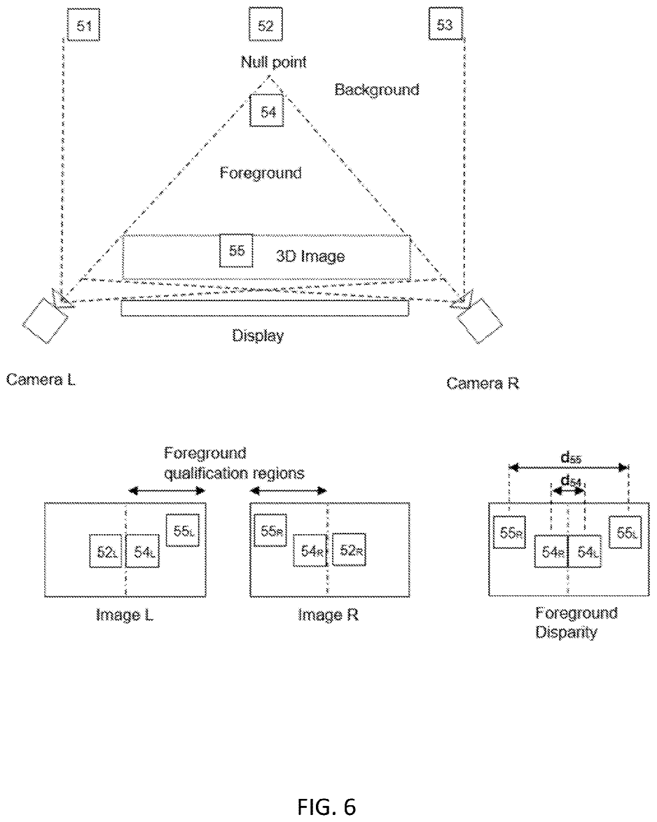

FIG. 5 shows two parallel cameras arranged to create a stereoscopic image, together with details of depth estimation and disparity. The parallel cameras have wide viewing angles 2×θ₀. Objects 51-54 are situated in front of the cameras. Object 54 is in the foreground whilst the others are in the background.

Conventional depth estimation shows the images from the left and right cameras. For the purposes of this positional description the objects are shown to be of the same size and not diminished due to distance from the camera. Also, it is assumed that the objects have been identified using existing processing means.

For the conventional approach, it can be seen that object 54 obscures object 53 in Image L and object 51 in Image R. If both object 53 and 54 are similar to object 54, then the viewer does not know if object 54 or object 51 and 53 are being viewed. Image L and Image R are combined along the parallel camera centre lines to give the disparity image from which the disparity can be calculated using standard processing. It can be seen that an object moving from the object 52 position in the background to the object 54 position in the foreground will increase the disparity.

The new approach rotates the disparity reference lines inwards by θ₁. Image L and R remain the same, however, the combined disparity image has a new characteristic. This time an object moving from the object 52 to 54 position has decreasing disparity to a null point (0 disparity) and then increases in disparity as it gets closer to the cameras.

For this new approach, the redefined reference lines meet at the null point and this defines the boundary between background and foreground. It can also be said that any object that appears in the both Region(θ₀−θ₁) of Image L and Region −(θ₀−θ₁) of Image R must be in the foreground unless it is coincidental with two similar objects in the background at the same angular positions. Although object sizes are shown as equal in the diagrams, change of object size with motion is another indicator of whether an object is in the foreground or background. In the background objects moving towards the cameras will increase in size but decrease in disparity until reaching the background boundary. Conversely objects moving towards the cameras in the foreground will increase in size and increase in disparity. Table 1 below shows the cases.

TABLE 1

| Size | Disparity | Location | Motion wrt camera M_{P} |
|---|---|---|---|
| Increasing | Increasing | Foreground | Towards |
| Decreasing | Increasing | Background | Away |
| Increasing | Decreasing | Background | Towards |
| Decreasing | Decreasing | Foreground | Away |
| No change | No change | No change | Stationary |

### Pointer Functionality

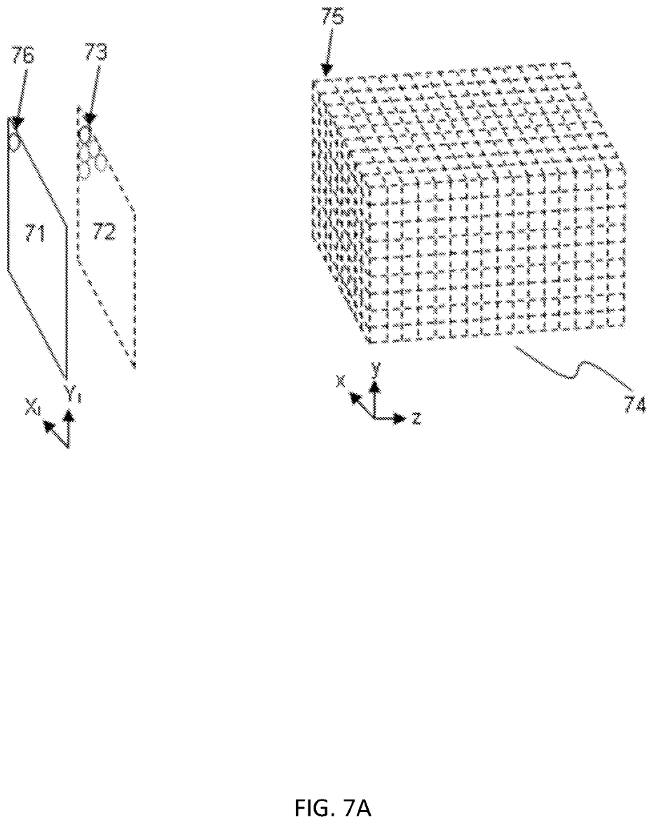

FIG. 6 shows an arrangement for the detection of near field objects coexisting with a 3D image floating above a display. FIG. 6 further shows details of foreground images and foreground disparity.

In this case the cameras are angled to make the disparity reference lines coincident with the camera centre lines to maximise the detection volume and reduce the maximum disparity for close objects thereby minimising the ultra-sensitivity at close distances.

The cameras have a viewing angle around 80 degrees as is typical for small low cost cameras and a depth of field set to focus on the foreground area only. The 3D image is not registered by the cameras as it is assumed the light from the display constructing the 3D image is projected away from the cameras.

Object 55 has been added in the 3D displayed volume. Both object 54 and 55 are in the foreground qualification regions of Images L and R. Objects 51 and 53 are not shown in Images L and R for clarity. In any event the possibility that objects 51 and 53 could give a false foreground reading is greatly diminished due to the background being out of the cameras' depth of field and therefore defocused and lower contrast.

Foreground Disparity shows the disparities for objects 54 and 55 enabling depth detection in the foreground space as an object moves from outside the 3D volume to inside.

Current methods of depth estimation using disparity are often unreliable and inconsistent. Table 1 allows object location determined by disparity calculation to be validated using the object's relative motion. This together with the near field camera setup increases the overall reliability of the method and reduces false readings.

### Pointer Trigonometry

The location of an object such as object 55 can be determined by triangulation. The x, y and z object distances can be calculated using the known parameters of camera spacing and field of view angles.

FIG. 7B shows an example of how the x, y and z object distances can be calculated. The cameras have field of views of 90 degrees. A and B are the centres of the camera lenses and C is the null point. A is the reference 0, 0, 0 position. The spacing between the cameras I_{AB} is commonly referred to as the Interocular Distance but in this case the camera spacing is not intended to replicate human eye separation as is typically used in current stereo cameras. The generalised example shown is for an object P at an elevated position vertically and located at X_{P}, Y_{P} and Z_{P}, which is similar to the location of object 55.

Images L and R show the camera images at the camera's resolution. The relative positions of object P in these images will be used to determine the real world distances X_{P}, Y_{P} and Z_{P}. U_{VL} and V_{HL} are the left camera's horizontal and vertical resolutions and U_{HR} and V_{VR} the right camera's. The position of object P in Images L and R is given by U_{PL}, U_{PR} and Y_{P}. Its position can also be expressed as a ratio of the maximum dimension. In the case where the cameras have similar specifications the object P position is derived from U_{PL}/U_{H}, U_{PR}/U_{H} and V_{PL}/V_{V}. This approach makes the calculation independent of camera resolution providing there is a minimum resolution that can meet the required granularity of the design.

The equations for calculating X_{P}, Y_{P} and Z_{P} are shown below. In their simplest form, only three variables are involved in the calculation, making use of standard trigonometrical functions.

Disparities can be expressed as proportions of the horizontal and vertical camera resolutions making the calculation of the location of an object of interest independent of image sensor resolution and simpler. This lends itself to real time implementations with look up tables. In this way, finger detection above a display can be implemented and then initiate and process real time 3D image changes to facilitate functions such as button press animation with finger movement.

### Pointer Calibration

Pointer calibration can be used as an alternative or supplementary to determining the x,y,z locations of objects with trigonometry. When used to supplement trigonometry, reference objects are placed throughout the volume of interest and their actual locations compared with the calculated positions to produce an error correction value applicable to objects found at or around the space occupied by the reference object.

If sufficient reference objects are used with known locations to record values of U_{PL}, U_{PR} and V_{PL} or their derivatives, a high resolution map can be created for use as a look up table for accurate pointer operation.

### Calculation of 3D Position of Object P

For horizontal resolutions U_{HL}=U_{HR}=U_{H} (similar specification cameras).

For symmetrically positioned cameras θ_{B}=θ_{A}=θ_{H} and is half the horizontal viewing angle. I_{AB} is also known.

### Using Triangulation

X_{P}=I_{AB}×tan(θ_{H}−θ_{PR})/(tan(θ_{H}−θ_{PL})+tan(θ_{H}−θ_{PR})) Equation1

where

θ_{PL}=tan⁻¹(tan θ_{H}×2U_{PL}/U_{H}) Equation 2

and

θ_{PR}=tan⁻¹(tan θ_{H}×2U_{PR}/U_{H}) Equation 3

Therefore horizontal position X_{P} is calculated using the proportions of the horizontal widths making the calculation independent of camera resolution.

Z_{P}=tan(θ_{H}−θ_{PL})×X_{P} Equation 4

For vertical resolutions V_{VL}=V_{VR}=V_{V} (similar specification cameras)

For similar cameras Ov is half the vertical viewing angle for both cameras

### Using Triangulation

R_{PL}=Z_{P}/Sin(θ_{H}−θ_{PL}) Equation 5

Y_{P}=(tan θ_{V}×2V_{PL}/V_{V})(Z_{P}/Sin(θ_{H}−θ_{PL})) Equation 6

Therefore vertical position Y_{P} is calculated using the proportions of the vertical heights making the calculation independent of camera resolution.

The 3D position of an object P entering the near field space can be determined using a minimum of three variables
U_{PL}, U_{PR} and V_{PL}.
   Implementation of an Imaging method

FIG. 8A is a flow chart showing an imaging method S100 that is implemented.

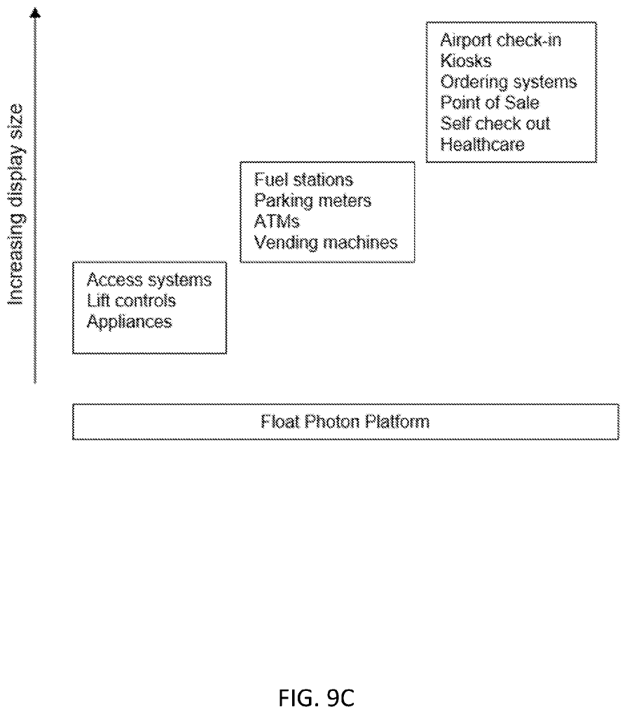

In step S101, an image is sourced for display by display 3. This image can be sourced in a number of ways including from stored memory, communications, image processing or from a combination of one or more sources in accordance with the arrangement shown in FIG. 4. Step S102 determines if the image is suitable for display based on the requirements of the application software 5. If it is the image is displayed in step S104, otherwise the image or the designated part is first converted to an autostereoscopic image in step S103 using topologies FIGS. 9A and 9B. Thus a stereoscopic image can be displayed to the user. Disclosure is provided of autostereoscopic images being generated from non-autostereoscopic images. Disclosure is also provided of an autostereoscopic image being displayed, which includes a feature which appears in a region above the display 3.

In step S105, the cameras 4 are set up with parameters such as frame rate, focal length, aperture, field-of-view, resolution and orientation angle. This allows the pointer operation to be optimised for the required operational conditions.

In steps S106-S109, a detection can be made of any gesture that is performed by the user in the region above the display. This detection method S200 is detailed in the flow chart FIG. 8B.

In step S106, images captured by the cameras 4 are monitored, and any objects of interest are detected. This can be done by comparing successive video frames, establishing differences of interest and using motion with respect to the cameras as shown in Table 1.

In step S107, the horizontal and vertical centre positions are determined for any objects that are detected in the images that are captured by the cameras 4. One method of calculating the centre positions is to take the average of the maximum and minimum points occupied by the object for both axes. This method works well for objects with a uniform shape such as a finger.

In step S108, an assessment is made of whether any objects have been detected in the foreground of the image that has been captured. If one or more object has been detected in the foreground of the image, then the method progresses to step S109. On the other hand, if no objects have been detected in the foreground of the image that has been captured, then the method returns to step S106.

In step S109, the location of the object is determined. This can be done by calculating the location of the object. Alternatively, this can be done by looking up the location of the object.

In step S110, an assessment is made of whether any object is in the 3D image volume. If one or more object is in the 3D image volume, then the method progresses to step S111. On the other hand, if no object is in the 3D image volume, then the method returns to step S106.

In step S111, an assessment is made of whether a system response is to be carried out. Examples of system responses are connection to a website, operation of a mechanical device such as a door, powering down a device or user feedback such as an audible beep. If a system response is to be carried out, then the method progresses to step S112. On the other hand, if no response is to be carried out, then the method returns to step S106.

In step S112, the system carries out the response or designated instruction.

In step S113, an assessment is made of whether a display response is to be performed. If a display response is to be performed, then the method progresses to step S114. On the other hand, if no display response is to be performed, then the method returns to step S106.

In step S114, the display response is performed. Thus, the 2D and or 3D image that is displayed by the display 3 is changed or animated by returning to step S101. For example a button may change colour and/or move downwards with the user's finger. Accordingly, the image is updated in response to the gesture.

FIG. 8C is a flowchart showing the real time conversion methodology of S103.

Step S103.1 determines the format of the input image. This could be a standard 2D image, a 2D image with depth information, a point cloud 3D image or other 3D format.

Once the format is known the volume parameters are determined in Step S103.4 based on User Setup information from S103.3. The user may specify additional parameters such as depth as is typically required for purely 2D source images. The user may also specify modifying parameters such as magnification factors and positional offsets. Another example is depth inversion used for changing psuedoscopic images to orthoscopic (normal) images.

The modifying parameters could also come from Sensors in S103.2 such as from an accelerometer, gyroscope or magnetometer. E.g. the volume parameters can be modified to tilt and/or rotate the 3D image towards the user in response to non-optimum orientation of the screen. Another example is using thermometer data to change the 3D size of a feature in response to changes in temperature.

Step S103.5 translates the source image based on the volume parameters from S103.4 to produce an object image volume in voxels that is to be described in subsequent steps as an integral image.

In Step S103.6 the 3D volume from S103.5 is mapped onto the 2D display surface using a lookup table to determine equivalent locations.

Step S103.7 sends the voxel value, typically specified as red, green and blue data, for use at its equivalent integral image 2D location provided the location has not been previously used by another voxel in the 3D volume. Duplication can occur for instance where one voxel is lined up behind another by line of sight.

Such instances enter Step S103.8 for Voxel/Pixel Processing. Step S103.8 makes decisions on how mapping conflicts are resolved based on the User Setup in S103.3 resulting in a use or not use outcome. The user may have prioritised voxels nearest the viewer in which case the depth of the voxel will determine whether the voxel is mapped. Another use case example is where the user wishes to smooth rounding errors and uses a voxel value interpolated from similarly mapped or surrounding voxels.

Step S103.9 assembles the integral image for display on a voxel by voxel or pixel by pixel basis. The mapping is repeated until the target integral image is complete.

For video the S103 is repeated at frame rate e.g. 60 fps. Note that this process can be done without any calculations.

The real time method shown in FIG. 8C is equally applicable to a range of 3D display solutions such as pin hole and lenticular display systems.

The detection of the gesture is implemented using a pointer method. The features of this pointer method are—
1. The use of converging reference lines to form a bounded volume in front of the cameras to mathematically define the foreground/background boundary.
2. Use object changes in size and disparity to define the region a moving object occupies and to use this information to validate an object.
3. The detection of near field objects that can be used as a pointer.
4. Camera near field focusing and depth of field setup avoids confusion with background objects.
5. A method of object location (x,y,z) independent of camera and display resolution that is readily implemented by look up table/stored data in memory.

FIG. 8B is a flow chart showing a pointer detection method S200 that is implemented.

S200 shows a method of calculating pointer position at run time, however, the referred to equations can be used to generate a look up table that can be stored in memory to achieve the same result.

Step S201 inputs the camera parameters once the cameras are setup in S105. These parameters form the basis of the pointer location.

Step S202 tracks an object's size and motion to determine if it is an object of interest in accordance with Table 1. In near field detection this is an object satisfying the foreground conditions. If there is an object of interest then the method progresses to S203 otherwise step S202 is repeated.

Step S203 gets the disparity parameters and the relative motion M_{P} of the object of interest P before proceeding to step S204.

Step S204 confirms the location of object P in the foreground region using disparity according to FIG. 6. If this is not confirmed the method returns to S202 otherwise S200 progresses to S205 and S206 where the left and right horizontal object angles are calculated using Equations 2 and 3 respectively.

The horizontal angles θ_{PL} and θ_{PR} are used in S207, S208 and S209 to calculate the object P coordinates Xₚ, Yₚ, Zₚ using Equations 1, 6 and 4.

Step S210 uses the difference between the current and previous locations of object P to determine the relative motion of P and compares this to M_{P} retrieved from S203. If there is consistency then the method progresses to S212 otherwise an error is detected and handled in step S211. Valid coordinates are output for use by the system in S212 before returning to the monitoring step S202.

Applications of this Innovation

For many arrangements, the display 3 is used to present both a 2D image and a 3D integral image. The 3D arrangement can present to the user a plurality of virtual buttons which are arranged to form a virtual keypad or a virtual keyboard.

This can be achieved by the MLA 2 being applied to the bottom half of the screen, which for the card reader application device 100 can thus present a 3D image such as a floating keypad in a secure customer area. Thus, disclosure is provided of the MLA covering a portion of the display area, which allows the 3D image to be presented in this portion. Note that the MLA 2 can cover the whole screen and still present a 2D image, because the height and depth of each voxel is settable in software. This disclosure covers credit card readers that comply with EMVCo certification (registered trade mark).

Innovation is to be found in the use of the disclosed device 100 for keypad entry, health and security systems. In this case, as well as the touchless advantages the keypad can be located behind a piece of glass or window with the keypad being operable in front of the glass in another room or outside. This is inherently more secure as the entry system can be accomplished with no external wiring or mechanical attachment.

Disclosure is provided of software that has been developed to model any 3D full colour image, icon or video, real world or graphic for 3D visualisation in space without glasses.

FIG. 9A illustrates that the hardware topology of the imaging device 100 may include a micro-lens array 2, an OLED (organic light emitting diode) display 3, a first camera (camera 1) and a second camera (camera 2), sensors, input/output (I/O) units 8, one or more processor, one or more memory, and a voltage regulation unit. Possible I/O units may include any combination of a HDMI port, a USB 1 port, a USB 2 port, a USB 3 port, and a Wi-Fi receiver (registered trade marks). The device 100 is shown including a central processing unit (CPU), a field-programmable gate array, and firmware. Note that it is not essential for the hardware topology to include these features, for example, it is possible to eliminate the HDMI interface by using Intel Thunderbolt technology (registered trade mark). Processing may be performed externally, such as source images being calculated offline, which provides the opportunity to make a lower cost non real time product.

FIG. 9B illustrates that the software topology of the imaging device 100 may include applications, libraries & a web based interface, a hardware abstraction layer, drivers, and a kernel.

FIG. 9C shows some applications of the imaging device 100. Applications are available for different sizes of display 3. Applications that implement a small sized display include access systems, lift controls, and appliances. Applications that implement a medium sized display include fuel station devices, parking meters, ATMs (automated teller machines), and vending machines. Applications that implement a large sized display include airport check-in devices, kiosks, ordering systems, point of sale devices, self check out devices, and healthcare devices.

The algorithm, software and optical development that has been disclosed confers advantages over expensive holographic and light field solutions, and utilises standard components.

Thus, disclosure is provided of a human interface that is presented in space, so that there is no user contact and therefore no surface pathogen transmission. The Float Photon (trade mark) Interface eliminates cleaning agents, waste and human intervention whilst simultaneously increasing throughput and being carbon negative.

The disclosed examples can be realised by a computer or a system or apparatus. These examples can be implemented by any device configured to execute instructions, or any dedicated hardware that is capable of carrying out all or a portion of the functionality. Disclosure is provided of hardware (e.g., a processor such as a central processing unit (CPU) or a microprocessor unit (MPU)) configured to read out and executes a program recorded on a memory device to perform the functions of the disclosed examples. For this purpose, the program is provided to the computer for example via a network or from a recording medium of various types serving as the memory device (e.g., a computer-readable medium such as a non-transitory computer-readable medium). The steps of the disclosed methods may be performed in any suitable order, or simultaneously where possible.

Although the disclosed subject matter has been described using specific terminology relating to apparatus features and/or method features, it is to be understood that the claimed subject matter is not necessarily limited to the examples disclosed. The scope of the following claims is to be accorded the broadest interpretation so as to encompass all such modifications and equivalent structures and functions. The advantages disclosed may relate to several of the examples that are disclosed.

### CLAUSES

The following clauses form part of the description and correspond to the claims as filed of the priority document GB2218713.2.

1. An imaging method comprising:
displaying to a user an autostereoscopic image that includes a feature which appears in a region above a display;
detecting a gesture performed by the user in the region above the display; and
updating the feature in response to the gesture.

2. The imaging method according to clause 1, wherein:
the autostereoscopic image is an integral image which is configured to be displayed using an array of microlenses.

3. The imaging method according to clause 1 or clause 2, wherein:
the feature comprises a virtual button;
the gesture comprises a selection of the virtual button; and
the updating comprises providing an indication of the virtual button being selected.

4. The imaging method according to any preceding clause, wherein:
the updating includes an animation of the autostereoscopic image, wherein the feature appears to move in the region above the display.

5. The imaging method according to any preceding clause, further comprising:
providing a feedback signal which coincides with the gesture being detected.

6. The imaging method according to any preceding clause, further comprising:
generating an autostereoscopic image from a non-autostereoscopic image.

7. The imaging method according to any preceding clause, further comprising:
identifying a foreground of the image;
defining a region in the foreground of the image that is occupied by a moving object; and
interpreting whether the moving object is providing the gesture.

8. The imaging method according to clause 7, further comprising:
detecting a change in size and/or a change in disparity of the moving object, in order to define the region occupied by the moving object.

9. A method for detecting a gesture, the method comprising:
identifying a foreground of the image;
defining a region in the foreground of the image that is occupied by a moving object; and
interpreting whether the moving object is providing the gesture.

10. The method according to clause 9, wherein:
identifying the foreground of the image comprises using a number of reference lines to identify a bounded volume in front of a detection unit.

11. The method according to clause 9 or clause 10, further comprising:
performing near field focusing to distinguish between a first object that occupies the foreground of the image and a second object that occupies a background of the image.

12. The method according to any one of clauses 9 to 11, further comprising:
detecting a change in size and/or a change in disparity of the moving object, in order to define the region occupied by the moving object.

13. The method according to any one of clauses 9 to 12, wherein:
interpreting whether the moving object is providing the gesture comprises determining whether the moving object can serve as a pointer.

14. The method according to any one of clauses 9 to 13, wherein:
interpreting whether the moving object is providing the gesture comprises performing object location by referencing data that is stored by a look up table or a memory.

15. A program which, when executed by a computer, causes the computer to perform a method according to any preceding clause.

16. A computer-readable storage medium storing a program according to clause 15.

17. An imaging device comprising:
a display configured to display to a user an autostereoscopic image that includes a feature which appears in a region above a display;
a detection unit configured to detect a gesture performed by the user in the region above the display; and
an update unit configured to update the feature in response to the gesture.

18. The imaging device according to clause 17, wherein:
the autostereoscopic image is an integral image; and
the display comprises an array of microlenses configured to display the integral image.

19. The imaging device according to clause 19, wherein:
the array of microlenses has a flat surface which is configured to face the user.

20. The imaging device according to clause 18 or clause 19, wherein:
the array of microlenses covers a portion of the display.

21. The imaging device according to any one of clauses 17 to 20, further comprising:
at least two cameras configured to capture a stereoscopic image of an object in the region;
wherein the detection unit is configured to detect the gesture by identifying a disparity in the stereoscopic image of the object that has been captured by the at least two cameras.

22. The imaging device according to any one of clauses 17 to 21, wherein:
the display is configured to display a virtual keypad.

23. The imaging device according to any one of clauses 17 to 22, further comprising:
a card reader configured to read information that is stored on a card that is presented by the user.

24. The imaging device according to any one of clauses 17 to 23, further comprising:
a feedback unit configured to provide a feedback signal which coincides with the gesture being detected by the detection unit.

25. The imaging device according to any one of clauses 17 to 24, further comprising:
means to generate an autostereoscopic image from a non-autostereoscopic image.

1. An imaging method comprising:
displaying to a user an autostereoscopic image that includes a feature which appears in a region above a display, wherein the autostereoscopic image is an integral image which is configured to be displayed using an optical array;
detecting a gesture performed by the user in the region above the display; and
updating the feature in response to the gesture.

2. The imaging method according to claim 1, wherein:
the feature comprises a virtual button;
the gesture comprises a selection of the virtual button; and
the updating comprises providing an indication of the virtual button being selected.

3. The imaging method according to claim 1, wherein:
the updating includes an animation of the autostereoscopic image, wherein the feature appears to move in the region above the display.

4. The imaging method according to claim 1, further comprising: generating an autostereoscopic image from a non-autostereoscopic image in real time enabling video display.

5. The imaging method according to claim 1, further comprising:
a lookup table.

6. The imaging method according to claim 1, further comprising:
modifying the autostereoscopic image in response to sensor data.

7. The imaging method according to claim 1, further comprising:
providing a feedback signal which coincides with the gesture being detected.

8. The imaging method according to claim 1, further comprising:
generating an autostereoscopic image from a non-autostereoscopic image.

9. The imaging method according to claim 1, further comprising:
identifying a foreground of the image;
defining a region in the foreground of the image that is occupied by a moving object; and
interpreting whether the moving object is providing the gesture.

10. The imaging method according to claim 9, further comprising:
detecting a change in size and/or a change in disparity of the moving object, in order to define the region occupied by the moving object.

11. The imaging method according to claim 9, wherein:
identifying the foreground of the image comprises using a number of reference lines to identify a bounded volume in front of a detection unit.

12. The imaging method according to claim 9, further comprising:
performing near field focusing to distinguish between a first object that occupies the foreground of the image and a second object that occupies a background of the image.

13. A program which, when executed by a computer, causes the computer to perform a method according to claim 1.

14. A computer-readable storage medium storing a program according to claim 13.

15. An imaging device comprising:
a display configured to display to a user an autostereoscopic image that includes a feature which appears in a region above a display, wherein the autostereoscopic image is an integral image, and the display comprises an optical array configured to display the integral image;
a detection unit configured to detect a gesture performed by the user in the region above the display; and
an update unit configured to update the feature in response to the gesture.

16. The imaging device according to claim 15, wherein:
the optical array has a flat surface which is configured to face the user.

17. The imaging device according to claim 15, wherein:
the optical array covers a portion of the display.

18. The imaging device according to claim 15, further comprising:
at least two image sensors configured to capture a stereoscopic image of an object in the region;
wherein the detection unit is configured to detect the gesture by identifying a disparity in the stereoscopic image of the object that has been captured by the at least two image sensors.

19. The imaging device according to claim 15, wherein:
the display is configured to display a virtual keypad.

20. The imaging device according to claim 15, further comprising:
a card reader configured to read information that is stored on a card that is presented by the user.

21. The imaging device according to claim 15, further comprising:
a feedback unit configured to provide a feedback signal which coincides with the gesture being detected by the detection unit.

22. The imaging device according to claim 15, further comprising:
an autostereoscopic image generator operative to generate an autostereoscopic image from a non-autostereoscopic image.

23. The imaging device according to claim 15, further comprising:
an autostereoscopic image generator operative to generate an autostereoscopic image from a non-autostereoscopic image in real time enabling video display.

24. The imaging device according to claim 15, further comprising:
a lookup table.

25. The imaging device according to claim 15, further comprising:
an autostereoscopic image modifier operative to modify the autostereoscopic image in response to sensor data.

26. An imaging method comprising:
generating an autostereoscopic image from a non-autostereoscopic image in real time enabling video display.

27. The imaging method according to claim 26 further comprising:
a look up table.

28. The imaging method according to claim 26 further comprising:
autostereoscopic image responses to sensor data.

29. An imaging device comprising:
an autostereoscopic image generator operative to generate an autostereoscopic image from a non-autostereoscopic image in real time enabling video display.

30. The imaging device according to claim 29 further comprising:
a look up table.

31. The imaging device according to claim 29 further comprising:
autostereoscopic image responses to sensor data.
